(19) United States
(12) Patent Application Publication
(10) Pub. No.: US 2008/0084845 A1
(43) Pub. Date: Apr. 10, 2008

(54) WIRELESS COMMUNICATION SYSTEM FRAME STRUCTURE HAVING VARIABLE SIZED CYCLIC PREFIX

(75) Inventors: Ravi Kuchibhotla, Gurnee, IL (US); Michael E. Buckley, Grayslake, IL (US); Robert T. Love, Barrington, IL (US); Kenneth A. Stewart, Grayslake, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/539,503

(22) Filed: Oct. 6, 2006

(51) Int. Cl. H04Q 7/00

(52) U.S. Cl. 370/331

(57) ABSTRACT

A wireless communication system that communicates (500) frames having first and second sub-frames (510, 520) with time-frequency resource elements. The first sub-frame including first reference symbol information and the second sub-frame including second reference symbol information, and not more than one of the first and second sub-frames including user specific radio resource assignment information. Wireless communication entities receiving the frames process the time-frequency elements of the first sub-frame using the first reference symbol information and processing the time-frequency elements of the second sub-frame using the second reference symbol information.

### FIELD OF THE DISCLOSURE

The present disclosure relates generally to wireless communications and more particularly to downlink control channel signaling over shared channels in wireless communication networks, corresponding entities and methods.

### BACKGROUND

In the Long Term Evolution (LTE) of UMTS Terrestrial Radio Access (UTRA) and UTRA Network (UTRAN) specifications, multiple approaches for scheduling downlink data transmission are being proposed. In particular, the proposals include time division multiplexing (TDM) and frequency division multiplexing (FDM) methods, including hybrids thereof, in addition to separate and joint coding of control channel signaling. In TDM or FDM transmissions of control channel signaling, the control information for downlink and uplink assignments may be transmitted over the first one or two symbols of the downlink frame or may be spread out over the length of a sub-frame, which may be, for example, of 0.5 ms duration, though other values are also possible. In jointly coded downlink and uplink control information schemes, all the control information relates to the sub-frame carrying the control information.

The various aspects, features and advantages of the disclosure will become more fully apparent to those having ordinary skill in the art upon careful consideration of the following Detailed Description and the accompanying drawings described below. The drawings may have been simplified for clarity and are not necessarily drawn to scale.

### BRIEF DESCRIPTION OF THE DRAWINGS

FIG. 1 illustrates a wireless communication system.

FIG. 2 illustrates a multi-frame frame comprising multiple radio frames, each comprising frames corresponding to a transmission time interval.

FIG. 3 illustrates a multi-frame frame comprising multiple frames having a transmission time interval.

FIG. 4 illustrates a multi-frame frame comprising a header portion.

FIG. 5 illustrates a radio frame comprising multiple frames, each comprising two sub-frames.

### DETAILED DESCRIPTION

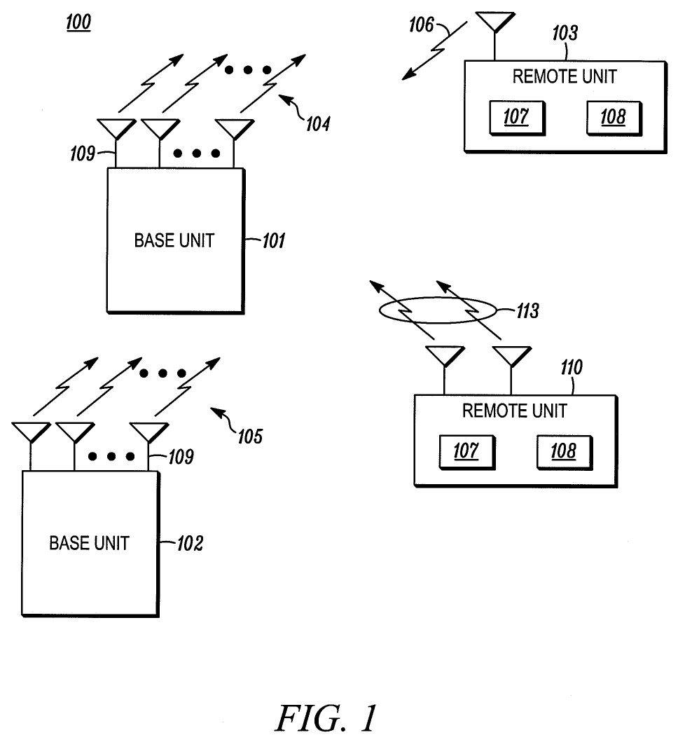

FIG. 1 illustrates a wireless communication system 100 comprising multiple cell serving base units forming a network distributed over a geographical region. A base unit may also be referred to as an access point, access terminal, Node-B, or similar terminologies known in the art. The one or more base units 101 and 102 serve a number of remote units 103 and 110 within a serving area or cell or within a sector thereof. The remote units may also be referred to as subscriber units, mobile units, users, terminals, subscriber stations, user equipment (UE), user terminals or by other terminology known in the art. The network base units communicate with remote units to perform functions such as scheduling the terminals to receive or transmit data using available radio resources. The wireless network also comprises management functionality including data routing, admission control, subscriber billing, terminal authentication etc., which may be controlled by other network entities, as is known generally by those having ordinary skill in the art.

Base units 101 and 102 transmit downlink communication signals 104 and 105 to serving remote units on at least a portion of the same resources (time and/or frequency). Remote units 103 and 110 communicate with one or more base units 101 and 102 via uplink communication signals 106 and 113. The one or more base units may comprise one or more transmitters and one or more receivers that serve the remote units. The number of transmitters at the base unit may be related, for example, to the number of transmit antennas 109 at the base unit. When multiple antennas are used to serve each sector to provide various advanced communication modes, for example, adaptive beam-forming, transmit diversity, transmit SDMA, and multiple stream transmission, etc., multiple base units can be deployed. These base units within a sector may be highly integrated and may share various hardware and software components. For example, all base units co-located together to serve a cell can constitute what is traditionally known as a base station. The remote units may also comprise one or more transmitters and one or more receivers. The number of transmitters may be related, for example, to the number of transmit antennas at the remote unit.

In one embodiment, the communication system utilizes OFDMA or a next generation single-carrier based FDMA architecture for uplink transmissions, such as interleaved FDMA (IFDMA), Localized FDMA (LFDMA), DFT-spread OFDM (DFT-SOFDM) with IFDMA or LFDMA. In other embodiments, the architecture may also include the use of spreading techniques such as direct-sequence CDMA (DS-CDMA), multi-carrier CDMA (MC-CDMA), multi-carrier direct sequence CDMA (MC-DS-CDMA), Orthogonal Frequency and Code Division Multiplexing (OFCDM) with one or two dimensional spreading, or simpler time and frequency division multiplexing/multiple access techniques.

Generally, a wireless communication network infrastructure scheduling entity located, for example, at each base unit 101 and 102 in FIG. 1, allocates or assigns radio resources to remote units in the network. The base units each include a scheduler for scheduling and allocating resources to remote units in corresponding serving areas or cells or sectors. In multiple access schemes such as those based on OFDM methods and the long term evolution of UTRA/UTRAN Study Item in 3GPP (also known as evolved UTRA/UTRAN (EUTRA/EUTRAN)), scheduling may be performed in the time and frequency dimensions using a Frequency Selective (FS) scheduler. In some embodiments, each remote unit may provide a frequency band channel quality indicator (CQI) or other metric to the scheduler to enable scheduling.

In OFDM systems or OFDM like systems such as DFT-SOFDM and IFDMA, a resource allocation is a frequency and time allocation that maps information for a particular base unit to sub-carrier resources from a set of available sub-carriers as determined by the scheduler. This allocation may depend, for example, on the frequency-selective channel-quality indication (CQI) or some other metric reported by the UE to the scheduler. The channel-coding rate and the modulation scheme, which may be different for different portions of the sub-carrier resources, are also determined by the scheduler and may also depend on the reported CQI or other metric. In code division multiplexed networks, the resource allocation is code allocation that maps information for a particular base unit to sub-carrier resources from a set of available sub-carriers as determined by the scheduler.

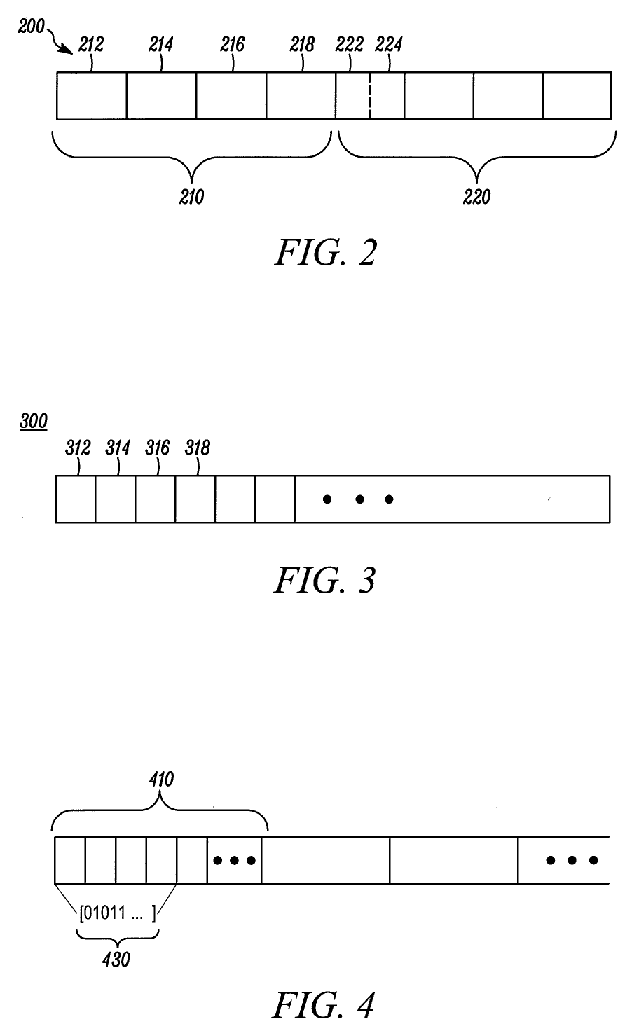

In FIG. 2, a multi-frame 200 comprises a plurality of transmission time intervals, each of which may include time-frequency resource elements. In one embodiment, the multi-frame comprises one or more radio frames, for example, radio frames 210 and 220. Each radio frame comprises a plurality of frames, for example, frames 212, 214, 216 and 218 in FIG. 2. In one implementation, each frame corresponds to a transmission time interval (TTI). In some embodiments, each frame comprises at least two sub-frames, for example, sub-frames 222 and 224 in FIG. 2. In FIG. 3, more generally, the multi-frame 300 includes multiple transmission time intervals 312, 314, 316 . . . .

In one embodiment, a first subset of the transmission time intervals are associated with a first attribute and a second subset of the transmission time intervals are associated with a second attribute. The terms ‘first’ and ‘second’ used in this specification are merely labels and do not imply and particular order unless explicitly indicated otherwise. In one embodiment, the first attribute is a unicast attribute and the second attribute is a broadcast/multicast attribute. For example, the unicast attribute may be a unicast cyclic prefix and the broadcast/multicast attribute may be a broadcast/multicast cyclic prefix. In this exemplary embodiment, generally, the unicast cyclic prefix has a different duration, for example, a different length, than the broadcast/multicast cyclic prefix. In some instances, however, the unicast and broadcast/unicast cyclic prefixes may have similar durations. More generally, the first and second attributes may be first and second reference or pilot symbols.

Generally, a wireless communication network infrastructure entity, for example, a base station or scheduling entity, transmits information indicating which attribute, e.g., the unicast cyclic prefix or the broadcast/multicast cyclic prefix, is associated with each of the transmission time intervals. In one embodiment illustrated in FIG. 4, the information indicating which attribute is associated with each of the transmission time intervals is transmitted to wireless communication devices in control header portion 410 of a multi-frame 400. In another embodiment, this information is transmitted to the wireless communication devices in a system information block (SIB), which may be associated with a broadcast information channel. For example, the information in the control header SIB may be a bit map 430 indicating which attribute is associated with each of the transmission time intervals.

The wireless communication device receives the multi-frame and the information indicating which of the transmission time intervals are associated with the unicast attribute, e.g., unicast cyclic prefix, and which of the transmission time intervals are associated with the broadcast/multicast attribute, e.g., broadcast/multicast cyclic prefix, and then processes the time-frequency elements of the first sub-frame using the unicast attribute and processes the time-frequency elements of the second sub-frame using the broadcast/multicast attribute.

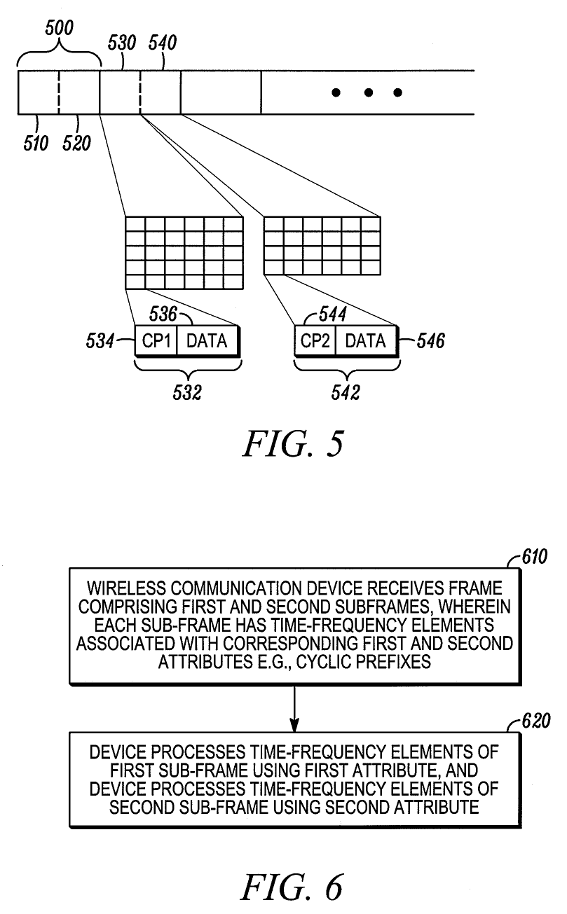

In another embodiment illustrated in FIG. 5, a frame 500 comprises first and second sub-frames 510 and 520 wherein each sub-frame includes time-frequency (T-F) resource elements. The frame may or may not be a transmission time interval (TTI). In FIG. 5, for example, sub-frame 530 comprises a plurality of T-F resource elements including T-F resource element 532 and sub-frame 540 comprises a plurality of T-F resource elements include T-F resource element 542.

In some implementations illustrated in FIG. 5, the frame 500 constitutes a radio frame comprising a plurality of frames where in each frame includes first and second sub-frames. More generally, however, the frame 500 may, at some level, constitute part of a multi-frame or a super-frame. In one embodiment, the base station or scheduling entity provides information to the wireless communication device indicating the frame structure, for example, indicating whether each frame constituting a radio frame comprises corresponding sub-frames, as illustrated in FIG. 5. The information may also indicate that the sub-frames are associated with corresponding first and second cyclic prefixes. In one embodiment, this information is indicated in advance using a bit map or other information signaled on a system information channel or on a dedicated link.

In this embodiment, the time-frequency resource elements of the first sub-frame are associated with a first cyclic prefix and the time-frequency resource elements of the second sub-frame are associated with a second cyclic prefix. The first and second cyclic prefixes are generally different. In FIG. 5, for example, the (T-F) resource element 532 includes a first cyclic prefix 534 and a data portion 536, and the (T-F) resource element 542 includes a second cyclic prefix 544 and a data portion 546. The first and second cyclic prefixes are generally different.

In one embodiment, the first cyclic prefix is a unicast cyclic prefix and the second cyclic prefix is a broadcast/multicast cyclic prefix. A broadcast/unicast cyclic prefix generally has a different duration or length than a unicast cyclic prefix, although in some instances both prefixes may have substantially the same duration. In one embodiment, the length or duration of the cyclic prefix of at least one of the first and second sub-frames is signaled or otherwise indicated to the wireless communication device. The indication may be implied or it may be signaled explicitly using indicator bits or other information. In one implementation, at least one of the sub-frames includes a control channel indicating the cyclic prefix duration or length of at least one of the first and second sub-frames. In one embodiment, not more than one of the first and second sub-frames includes user specific radio resource assignment information. For example, where one sub-frame is a unicast sub-frame and the other sub-frame is a broadcast/multicast sub-frame, only the unicast sub-frame includes user specific radio resource assignment information.

In the process diagram of FIG. 6, at 610, a wireless communication device receives a frame comprising first and second sub-frames having time-frequency resource elements. The time-frequency resource elements of the first and second sub-frame are associated with corresponding first and second cyclic prefixes, as illustrated in FIG. 5. In FIG. 6, at 620, the wireless communication device processes the time-frequency elements of the first sub-frame using the first cyclic prefix, and it processes the time-frequency elements of the second sub-frame using the second cyclic prefix. Such processing may be implemented by a controller, for example, a software control digital processor or digital signal processor.

In FIG. 5, in some embodiments, at least one of the first and second sub-frames includes a control channel, wherein the control channel of at least one of the first and second sub-frames indicates the location of an ACK/NACK field in the corresponding sub-frame. The ACK NACK field could be anywhere within the sub-frame. In one implementation, for example, at least one of the first and second sub-frames includes a control channel region having an ACK/NACK field, wherein the region generally includes multiple ACK/NACK fields. In another implementation, not more than one of the first and second sub-frames has a control channel with an ACK/NACK location indicator signaling the location of an ACK/NACK field in the corresponding sub-frame. In another embodiment related to FIG. 5, not more than one of the first and second sub-frames is a multicast sub-frame, wherein the control channel signaling control information associated with the multicast data is transmitted in the associated sub-frame.

In another embodiment, one of the frames received by the wireless communication device is a downlink frame comprising first and second sub-frames wherein the downlink frame is associated with a corresponding uplink frame. Each sub-frame of the uplink and downlink frame has time-frequency resource elements. The wireless communication device transmits control information, for example, ACK/NACK information, in one of the first or second sub-frames of the corresponding uplink frame, and in some embodiments the wireless communication device also transmits uplink data in the other of the first or second sub-frames of the corresponding uplink frame.

According to another aspect of the disclosure, multiple base stations in a wireless communication system, for example, the system of FIG. 1, each transmit a sequence of frames. In this embodiment, each frame corresponds to a transmission time interval (TTI), and each frame has at least two sub-frames. In one embodiment, each sub-frame frame has a corresponding attribute selected from a group comprising first and second attributes. In one embodiment, the attribute is a unicast sub-frame attribute or a broadcast/multicast sub-frame attribute, for example, a unicast cyclic prefix or a broadcast/multicast cyclic prefix. In another embodiment, the attribute is a first or second reference symbol, wherein each sub-frame has either a first reference symbol or a second reference symbol, but not both. According to this aspect of the disclosure, the base stations transmit the corresponding sequence of frames substantially simultaneously such that the corresponding sub-frames are substantially time-aligned, wherein each sub-frame having the same attribute is substantially time-aligned. Variations in the time-alignment of the sub-frames could be due to propagation delay associated with the location of an entity receiving the sequence of frames transmitted by the base stations.

In one implementation, the base stations transmit information in a control header portion of a frame, wherein the information, for example, a bit map, indicates which of the first or second attributes is associated with the each sub-frame. In one implementation, the bit map include a single bit associated with a frame having not more than two sub-frames, wherein the bit indicated whether the two sub-frames have the same or different attribute, for example, unicast or broadcast/multicast. In another embodiment, the bit map includes at least one bit for each sub-frame, wherein the at least one bit indicates which attribute is associated with the corresponding sub-frame. In another implementation, the information is transmitted in a system information block.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication device, the method comprising:
receiving a frame comprising not more than first and second sub-frames, each sub-frame having time-frequency resource elements,
the first sub-frame including a first reference symbol information and the second sub-frame including second reference symbol information,
not more than one of the first and second sub-frames including user specific radio resource assignment information;
processing the time-frequency elements of the first sub-frame using the first reference symbol information and processing the time-frequency elements of the second sub-frame using the second reference symbol information.

2. The method of claim 1,
the first reference symbol information includes a unicast cyclic prefix and the second reference symbol information includes a broadcast/multicast cyclic prefix,
wherein the time-frequency resource elements of the first sub-frame are associated with the unicast cyclic prefix and the time-frequency resource elements of the second sub-frame are associated with the broadcast/multicast cyclic prefix,
processing the time-frequency elements of the first sub-frame using the unicast cyclic prefix and processing the time-frequency elements of the second sub-frame using the broadcast/multicast cyclic prefix.

3. The method of claim 2, a length of the unicast cyclic prefix is different than a length of the broadcast/multicast cyclic prefix.

4. A method in a wireless communication device, the method comprising:
receiving a frame comprising first and second sub-frames, each sub-frame having time-frequency resource elements,
wherein the time-frequency resource elements of the first sub-frame are associated with a first cyclic prefix and the time-frequency resource elements of the second sub-frame are associated with a second cyclic prefix,
the first and second cyclic prefixes are different;
processing the time-frequency elements of the first sub-frame using the first cyclic prefix and processing the time-frequency elements of the second sub-frame using the second cyclic prefix.

5. The method of claim 4, receiving information indicating that the frame is a split frame comprising the first and second sub-frames associated with corresponding first and second cyclic prefixes, the information received before receiving the frame.

6. The method of claim 4,
at least one of the sub-frames having a control channel,
the control channel includes an indicator, the indicator signaling the cyclic prefix length of at least one of the first and second sub-frames.

7. The method of claim 4,
the frame constitutes a radio frame comprising a plurality of frames,
receiving information indicating whether each frame constituting the radio frame comprises corresponding sub-frames.

8. The method of claim 4,
at least one of the first and second sub-frames having a control channel,
the control channel of at least one of the first and second sub-frames including the location of an ACK/NACK field in the corresponding sub-frame.

9. The method of claim 4, at least one of the first and second sub-frames having a control channel region having an ACK/NACK field.

10. The method of claim 4,
not more than one of the first and second sub-frames is a multicast sub-frame,
the control channel signaling control information associated with the multicast data transmitted in the associated sub-frame.

11. The method of claim 4,
receiving a frame includes receiving a downlink frame comprising first and second sub-frames having time-frequency resource elements,
the downlink frame associated with a corresponding uplink frame comprising first and second sub-frames having time-frequency resource elements,
transmitting control information in the first sub-frame of the corresponding uplink frame, and transmitting uplink data in the second sub-frame of the corresponding uplink frame.

12. A method in a wireless communication device, the method comprising:
receiving a multi-frame comprising a plurality of transmission time intervals, each transmission time interval having time-frequency resource elements,
a first subset of the transmission time intervals are associated with a unicast attribute, a second subset of the transmission time intervals are associated with a broadcast/multicast attribute;
receiving information indicating which of the transmission time intervals are associated with the unicast attribute and which of the transmission time intervals are associated with the broadcast/multicast attribute;
processing the time-frequency elements of the first subset of transmission time intervals using the unicast attribute and processing the time-frequency elements of the second subset of transmission time intervals using the broadcast/multi-cast attribute.

13. The method of claim 12, receiving the information indicating which of the transmission time intervals are associated with the unicast attribute and which of the transmission time intervals are associated with the broadcast/multicast attribute in a control header portion of the multi-frame.

14. The method of claim 12, receiving the information indicating which of the transmission time intervals are associated with the unicast attribute and which of the transmission time intervals are associated with the broadcast/multicast attribute in a system information block.

15. The method of claim 12, receiving the multi-frame comprising the plurality of transmission time intervals includes receiving multiple radio frames constituting the multi-frame, wherein each radio frame comprises a plurality of transmission time intervals.

16. The method of claim 15,
the first subset of the transmission time intervals are associated with a unicast cyclic prefix, the second subset of the transmission time intervals are associated with a broadcast/multicast cyclic prefix;
receiving information indicating which of the transmission time intervals are associated with the unicast attribute includes receiving information indicating which of the transmission time intervals are associated with the unicast cyclic prefix,
receiving information indicating which of the transmission time intervals are associated with the broadcast/multicast attribute includes receiving information indicating which of the transmission time intervals are associated with the broadcast/multicast cyclic prefix.

17. A method in a wireless communication system comprising multiple base stations, the method comprising:
each base station transmitting a sequence of frames, each frame corresponding to a transmission time interval, and each frame having at least two sub-frames, each sub-frame having a corresponding attribute,
at least one frame having first and second sub-frames with different attributes,
each base station transmitting the corresponding sequence of frames substantially simultaneously such that the corresponding sub-frames are substantially time-aligned, each substantially time-aligned sub-frame having the same attribute.

18. The method of claim 17, the at least one frame having first and second sub-frames with different attributes includes a unicast sub-frame and a broadcast/multicast sub-frame.

19. The method of claim 17, the at least one frame having first and second sub-frames with different attributes includes the first sub-frame having a first reference symbol attribute and the second sub-frame having a second reference symbol attribute.

20. The method of claim 17, the at least one frame having first and second sub-frames with different attributes includes the first sub-frame having a unicast cyclic prefix and the second sub-frame having a broadcast/multicast cyclic prefix.

21. The method of claim 17, transmitting information, in a control header portion of the sequence of frames, indicating which of the first or second attributes is associated with the each sub-frame.

22. The method of claim 17, transmitting information, in a system information block, indicating which of the first or second attributes is associated with the each sub-frame.
